(19) United States
(12) Patent Application Publication
(10) Pub. No.: US 2006/0117620 A1
(43) Pub. Date: Jun. 8, 2006

(54) Memorial light device

(76) Inventor: Harold Grubbs, Covington, IN (US)

Correspondence Address: Bryan S. Redding;COHEN GARELICK & GLAZIER, Suite 800, 8888 Keystone Crossing, Indianapolis, IN, 46240, US

(21) Appl. No.: 11/006,405

(22) Filed: Dec. 6, 2004

(51) Int. Cl. G09F 13/04

(52) U.S. Cl. 40/564

(57) ABSTRACT

The present invention discloses a memorial light device that can be personalized to provide additional impact and meaning to the memorial.

### CROSS-REFERENCE TO RELATED APPLICATIONS

Not Applicable

### STATEMENT REGARDING FEDERAL SPONSORED RESEARCH OR DEVELOPMENT

Not Applicable

### REFERENCE TO SEQUENCE LISTING, ETC.

Not Applicable

### BACKGROUND

The present invention relates to a memorial light device. More particularly, the present invention relates generally to memorial light devices and specifically consisting of a device that offers flexibility to personalize the device, with ease and low cost, to make a one-of-kind memorial to a loved one or other suitable event or occasion which may call for a personalized memorial.

People generally spend a large amount of time and money to remember loved ones that have passed and to mark significant events that have affected our lives, i.e. Sep. 11, 2001. This time and money is spent immediately after the event, i.e. burial costs, flowers, monuments/head-stones; as well as thereafter, as part of the process of honoring those that have passed, our own grieving process and also to keep the memories of the person/event alive for appreciation in the future. There is an innate desire of people to participate in some, or all, of these events and activities and these activities become even more meaningful if we can obtain a memorial that is personalized to our loved one or the event at issue. This allows the people to put an individualized emotional element that is not present in a generic memorial. The present invention relates to a new, useful and unobvious memorial light device that will appeal to a large group of people based upon it's flexibility and low cost. These features will meet a need for memorials that are not currently being met and for the foregoing reasons, this invention will fill this void.

### BRIEF SUMMARY

The present invention is directed to the needs and desires noted above for memorial activities. It is a further object of this invention that this memorial need be met at a low cost and flexibility so that everyone desiring to memorialize a loved one or event, may do so. It is another object of this invention that it can be used virtually anywhere, eliminating the need for a specific location or equipment requirements, other than the memorial light device itself.

These and other features, aspects and advantages of the present invention will become better understood with reference to the following description, appended claims and accompanying drawing.

### BRIEF DESCRIPTION OF THE DRAWINGS

FIG. 1: shows one claimed embodiment of the memorial light device.

### DESCRIPTION

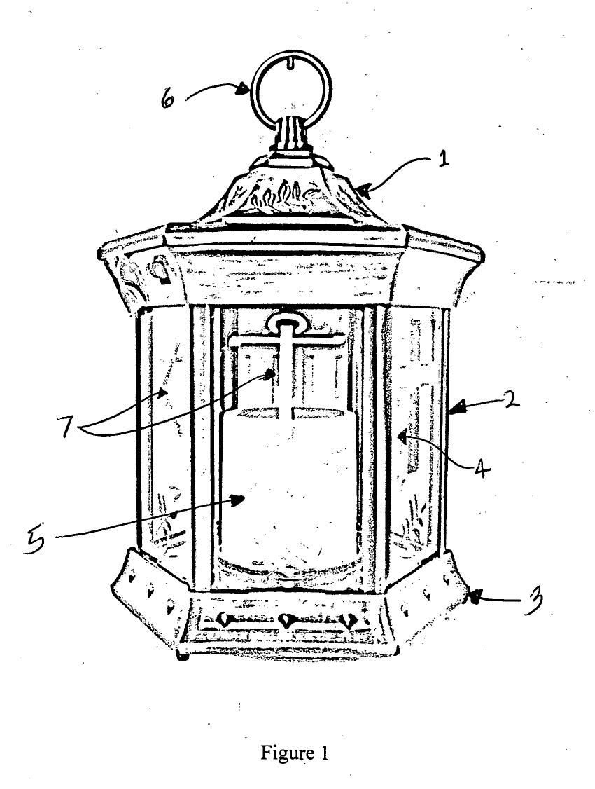

The memorial light device of this invention may be produced by having a top element 1 that is fixedly attached to the middle element 2 which is made mainly of an opaque or clear material. The middle element 2, is in a generally cylindrical shape with two ends and an exterior surface and interior surface, where the interior surface is parallel to the exterior surface and such that an open space is created, bounded by the interior surface, i.e. the opaque or clear material is not a solid block of material, and one of the two ends is fixedly attached to the top element 1. At the second end of the middle element 2, it is fixedly attached to the bottom element 3. The top element 1 and the bottom element 2 serve to close the two ends of the middle, thereby substantially enclosing the open space of middle element 2. One claimed embodiment is demonstrated by FIG. 1. The memorial light device also contains a lighting element 5. The lighting element 5 can be a real or artificial candle or merely a light bulb. If the lighting element 5 is an artificial candle or bulb, a power source generally known in the art is contained in the top element 1 or bottom element 2. The top element 1 and the bottom element 2 do not generally contain holes or venting, unless necessary due to the light element 5.

The top element 1 and bottom element 3 can be made of any material as long as the material is of sufficient strength and ridigity to maintain its shape for an extended period of time. It is preferable that the top element 1 and bottom element 3 be made of a material (such as metal, plastic, composite or wood) that can be personalized by imprinting, etching, painting, or other means generally known. The top element 1 may also contain a means to mount 6 the memorial light device to a fixed location, i.e. monument or head-stone, or anywhere, i.e. a shepherd's hook. Likewise this means could also be found in the bottom element 3, i.e. to mount it on a pole.

The middle element 2 is made substantially of an opaque or clear and hollow structure that is fixedly attached to the top element 1 and bottom element 3. The nature of the middle element 2 allows for personalization of the memorial light device on the opaque or clear surfaces 7. This personalization can be by etching, imprinting, stickers, paint or others means well known in the art. In addition to personalization directly on the opaque or clear surfaces 7, personalization can also be introduced to the middle element 3 by introduction of a personalized sleeve, either opaque or solid with holes, between the interior surface of the middle element 3 and the lighting element 5.

In the preferred embodiment, the top element 1 is made of a metal suitable for etching or imprinting and containing a means 6, to mount the memorial light device at a location. The size of top element 1 is not determinative but a 6″ diagonal length provides sufficient size for the memorial to be seen, while also maintaining ease of movement and mounting.

Further, in the preferred embodiment, the middle element contains glass in an octagonal pattern with an upright length of 6.″ This provides sufficient space to allow for personalization by etching, stickers, or other means, while at the same time allowing the light source to provide illumination that can be seen by people viewing the memorial light device. It is also of sufficient size to allow for introduction of a personalized sleeve into the middle element 3, to provide ease of viewing.

Lastly, in the preferred embodiment, the bottom element is made of a metal suitable for etching or imprinting, to allow for personalization, and contains the lighting element 5, which provides illumination that escapes from the opaque or clear areas of middle element 2.

A further preferred embodiment will involve middle element that is a circular of spherical tube that would provide continuous personalization on the middle element 2. A further preferred embodiment will involve the middle element being in a square tube shape, that would provide four distinct surfaces for personalization. A further preferred embodiment would have a top element 1, that contained the lighting element 5.

Although the present invention has been described in considerable detail with reference to certain preferred versions thereof, other versions are possible. Therefore, the spirit and scope of the appended claims should not be limited to the description of the preferred versions contained herein.

What is claimed is:

1. A memorial light device comprising:
a) a top element made of a fixedly rigid material suitable for personalization;
b) a middle element that contains an exterior portion and interior portion, in a generally cylindrical shape, made of an opaque or clear material suitable for personalization, and having two ends at the opposite of the element;
c) the middle element is rigidly attached to the top element at one of the two ends, such that no movement is seen between these elements and the top element also serves to cover one of the two ends of the middle element;
d) a bottom element that is made of fixedly rigid material suitable for personalization;
e) the bottom element is rigidly attached to the middle element on the end opposite the top element and such that no movement is seen between these elements and the bottom element also serves to cover the open end of the middle element not covered by the top element;
f) a lighting element is contained inside the middle element to provide illumination that is seen through the opaque or clear portion of the middle element.

2. The device of claim 1 whereby the top and bottom elements are made of material suitable for personalization selected from the group of metal, glass, plastic, composite or wood.

3. The device of claim 1 whereby the top or bottom element contains a means to mount the memorial light device at a fixed location.

4. The device of claim 1 whereby the middle element contains an additional personalized sleeve made of a material suitable for personalization that is placed into the middle element between the lighting element and the interior surface of the middle element.

5. The device of claim 1 whereby the middle element is a hollow tube having a length-wise shape selected from the group of circle, triangle, square, trapezoid, rectangle, hexagon, or octagon.

6. A memorial light device comprising:
a) a top element made of a fixedly rigid material suitable for personalization;
b) a middle element that contains an exterior portion and interior portion, in a generally cylindrical shape, made of an opaque or clear material suitable for personalization, and having two ends at the opposite of the element;
c) the middle element is rigidly attached to the top element at one of the two ends, such that no movement is seen between these elements and the top element also serves to cover one of the two ends of the middle element;
d) a bottom element that is made of fixedly rigid material suitable for personalization;
e) the bottom element is rigidly attached to the middle element on the end opposite the top element and such that no movement is seen between these elements and the bottom element also serves to cover the open end of the middle element not covered by the top element;
f) a lighting element is attached to the bottom element and extending into the middle element to provide illumination that is seen through the opaque or clear portion of the middle element.

7. The device of claim 6 whereby the top and bottom elements are made of material suitable for personalization selected from the group of metal, glass, plastic, composite or wood.

8. The device of claim 1 whereby the top or bottom element contains a means to mount the memorial light device at a fixed location.

9. The device of claim 6 whereby the middle element contains an additional personalized sleeve made of a material suitable for personalization that is placed into the middle element between the lighting element and the interior surface of the middle element.

10. The device of claim 6 whereby the middle element is a hollow tube having a length-wise shape selected from the group of circle, triangle, square, trapezoid, rectangle, hexagon, or octagon.

11. A memorial light device comprising:
a) a top element made of a fixedly rigid material suitable for personalization;
b) a middle element that contains an exterior portion and interior portion, in a generally cylindrical shape, made of an opaque or clear material suitable for personalization, and having two ends at the opposite of the element;
c) the middle element is rigidly attached to the top element at one of the two ends, such that no movement is seen between these elements and the top element also serves to cover one of the two ends of the middle element;
d) a bottom element that is made of fixedly rigid material suitable for personalization;
e) the bottom element is rigidly attached to the middle element on the end opposite the top element and such that no movement is seen between these elements and the bottom element also serves to cover the open end of the middle element not covered by the top element;
f) a lighting element is attached to the top element and extends into the middle element to provide illumination that is seen through the opaque or clear portion of the middle element.

12. The device of claim 11 whereby the top and bottom elements are made of material suitable for personalization selected from the group of metal, glass, plastic, composite or wood.

13. The device of claim 11 whereby the top or bottom element contains a means to mount the memorial light device at a fixed location.

14. The device of claim 11 whereby the middle element contains an additional personalized sleeve made of a material suitable for personalization that is placed into the middle element between the lighting element and the interior surface of the middle element.

15. The device of claim 11 whereby the middle element is a hollow tube having a length-wise shape selected from the group of circle, triangle, square, trapezoid, rectangle, hexagon, or octagon.
